(19) United States
(12) Patent Application Publication
(10) Pub. No.: US 2004/0189699 A1
(43) Pub. Date: Sep. 30, 2004

(54) System and method for customizing electronic messages

(76) Inventor: Oren Dobronsky, New York, NY (US)

Correspondence Address: Charles A. Rattner, Apt 7, 240 Wardwell St, Stamford, CT, 06902-5254, US

(21) Appl. No.: 10/718,396

(22) Filed: Nov. 19, 2003

Related U.S. Application Data
(63) Continuation-in-part of application No. 10/420,625, filed on Apr. 22, 2003.
Application No. 10/420,625 is a continuation of application No. 10/396,647, filed on Mar. 24, 2003, now abandoned.

(51) Int. Cl. G09G 5/00

(52) U.S. Cl. 345/751

(57) ABSTRACT

A plug-in is provided to existing electronic message programs, such as electronic mail message programs, to provide a virtual toolbar therein. The virtual toolbar includes one or more virtual buttons that allow a user to select multimedia content to be added to an electronic message. The multimedia content may include, without limitation, any one or more of: graphics, audio, animation, video and text selections. The multimedia content may further include customizable templates in which business or personal messages may be generated. The plug-in may provide a variety of functions to allow user to generate custom electronic message templates that may be private or may be shared with other users. The template may include selectable links and advertisements, the selection of which within an electronic message may reported to the user that generated the customized electronic template.

### CROSS-REFERENCE TO RELATED APPLICATIONS

This application claims priority under 35 U.S.C. §120 as a continuation-in-part to co-pending U.S. patent application Ser. No. 10/420,625, entitled SYSTEM AND METHOD FOR CUSTOMIZING ELECTRONIC MESSAGES filed in the name of Oren Dobronsky on Apr. 22, 2003, which is a continuation of U.S. patent application Ser. No. 10/396,647 entitled SYSTEM AND METHOD FOR CUSTOMIZING ELECTRONIC MESSAGES filed in the name of Oren Dobronsky on Mar. 24, 2003, now abandoned, the entirety of each being hereby incorporated by reference.

### FIELD OF THE INVENTION

The present invention relates generally to electronic computers and digital processing systems for multiple computer or process coordinating, and relates more particularly to demand based messaging.

### BACKGROUND OF THE INVENTION

Electronic message programs are widely used around the world to send electronic messages over a computer network between two or more users having computer terminals at separate locations. Such electronic message programs include electronic mail (e-mail) programs and instant messaging programs. Common existing e-mail programs include Outlook® and Outlook Express® developed by Microsoft Corp.®, or LotusNotes® developed by IBM Corporation®, which are collectively used by tens of millions of computer users worldwide.

At present, electronic messages largely have plain, static backgrounds over which text is inserted. Some existing electronic messaging programs do provide limited functionality to modify the backgrounds of electronic messages. For example, a system for embedding backgrounds into electronic messages is disclosed in PCT Publication No. WO 02/08852 filed in the name of INCREDIMAIL. Some electronic message program developers also currently provide their software upgrades for including additional backgrounds to their program's existing options. However, such developer-provided content is typically limited in the number of available choices for content, is not customizable to a particular user, requires that the content be stored locally on a user's terminal, and/or requires the download and use of a program instead of common e-mail programs.

Accordingly, there is a need for a method and apparatus for customizing electronic messages that addresses certain shortcomings in existing technologies.

### SUMMARY OF THE INVENTION

The present disclosure is directed to various systems and methods for customizing electronic messages wherein a user may upload and install executable code for providing a virtual toolbar within an existing electronic message program. In certain embodiments, the executable code may be provided as a plug-in to the electronic message program. After installing the executable code, the user is presented with the virtual toolbar when the electronic message program, or a new electronic message within the program, is opened. The virtual toolbar may be disposed separately from a native toolbar of the electronic message program. In certain embodiments, the virtual toolbar may be disposed between a native toolbar and a message input window of the electronic message program. The virtual toolbar may include a plurality of virtual buttons for selecting different content, or categories of content, that can be included within an electronic message.

Upon selecting a virtual button, a separate window may be displayed to the user that includes a plurality of selectable content associated with the virtual button. The window may additionally include listings of one or more subcategories of associated content. Available content may include holiday-themed content, visual images such as artwork and photography, animations, audio content, audio/visual content, and business-formatted content. Sub-categories may include any generic group of content, such as animal scenes, nature scenes, world landmarks, and so forth.

The selectable content may be stored locally on a central content server and may therefore be updated without having to update a plurality of plug-ins stored on a plurality of users' computer terminals. In certain embodiments, the content may not be permanently stored on a user's computer terminal at all. Instead, the virtual buttons provided by the plug-in may contain a link to a page stored on the central content server. Accordingly, only the page need be updated to update available content. The central content server may also change attributes of the virtual toolbar or the virtual buttons whenever the plug-in is activated and accesses the central content server over a computer network.

The user may select particular content from the displayed list or lists for inclusion in an electronic message, and may also input text to the message in a standard manner. A user may select content as default content for inclusion in future electronic messages, if the user desires. In such case, the selection of default content may be stored locally at the user's computer terminal or at the central content server, or a combination of both.

A user may generate custom message templates with various tools provided by the plug-in. A user may also upload a generated template for storage on the content server. A user may allow the custom message template to be shared with other users, and prevent altering of the stored template by other users. A user may include hyperlinks within a custom message template, and receive reports from the content server indicating a number of selections of the hyperlink from electronic messages distributed with the custom template.

When an electronic message with selected or default content is transmitted to another user, the message may simply contain any user-inputted text and a call to a network address location of the content on the central content server, rather than a data file containing the content itself, in order to conserve the data size of the electronic message. When the second user opens a received electronic message with the call, the content is generally transmitted from the central content server for display when the received electronic message is opened or may also be embedded in the e-mail transmitted. The second user is not required to have the plug-in to receive or view the content selected by the first user.

### BRIEF DESCRIPTION OF THE DRAWINGS

Further aspects of the present disclosure will be more readily appreciated upon review of the detailed description of the preferred embodiments, included below, when taken in conjunction with the accompanying drawings, of which:

FIG. 1 is a schematic diagram of an exemplary computer network;

FIG. 2 is a schematic diagram of the plug-in and content server of FIG. 1, according to certain embodiments of the present disclosure;

FIG. 3 is a flowchart depicting a process for creating customized electronic mail messages using the plug-in, according to certain embodiments of the present disclosure;

FIG. 4 is an illustration of a prior art main window of an exemplary electronic message program, which may be displayed on the user terminal of FIG. 1 prior to installation of the plug-in;

FIG. 5 is an illustration of a prior art electronic message window of an exemplary electronic message program, which may be displayed on the user terminal of FIG. 1 prior to installation of the plug-in;

FIG. 6 is an illustration of a main window of an electronic message program including an exemplary virtual toolbar for inserting content into an electronic message, which toolbar may be displayed on the user terminal of FIG. 1 after installation of the plug-in, according to certain embodiments of the present disclosure;

FIG. 7 is an illustration of a first exemplary content window displaying available content and sub-categories of content associated with a virtual button of the virtual toolbar of FIG. 6, according to certain embodiments of the present disclosure;

FIG. 8 is an illustration of a second exemplary content window displaying available content, according to certain embodiments of the present disclosure;

FIG. 9 is an illustration of a message window of an electronic message program including an exemplary virtual toolbar for inserting content into an electronic message, which may be displayed on the user terminal of FIG. 1 after installation of the plug-in according to certain embodiments of the present disclosure;

FIG. 10 is an illustration of a message window of an electronic message program including exemplary content selected from the virtual toolbar, according to certain embodiments of the present disclosure;

FIG. 11 is an illustration of a message window of an electronic message program including exemplary inputted text over the content selected from the virtual toolbar, according to certain embodiments of the present invention;

FIG. 12 is an illustration of a message window of an electronic message program including customized business content selected from the virtual toolbar, according to certain embodiments of the present disclosure;

FIG. 13 is a flowchart depicting an exemplary process for generating a customized electronic message template according to certain embodiments of the present disclosure;

FIG. 14 is an illustration of an exemplary initial message template creation window for use with the process of FIG. 13;

FIG. 15 is an illustration of an exemplary template layout window for use with the process of FIG. 13;

FIG. 16 is an illustration of an exemplary text entry window for use with the process of FIG. 13;

FIG. 17 is an illustration of an exemplary logo selection window for use with the process of FIG. 13;

FIG. 18 is an illustration of an exemplary logo gallery window for use with the process of FIG. 13;

FIG. 19 is an illustration of an exemplary color selection window for use with the process of FIG. 13;

FIG. 20 is an illustration of an exemplary texture selection window for use with the process of FIG. 13;

FIG. 21 is an illustration of exemplary color palette, bullet and button selection windows for use with the process of FIG. 13; and

FIG. 22 is an illustration of an exemplary links entry window for use with the process of FIG. 13.

### DETAILED DESCRIPTION OF THE INVENTION

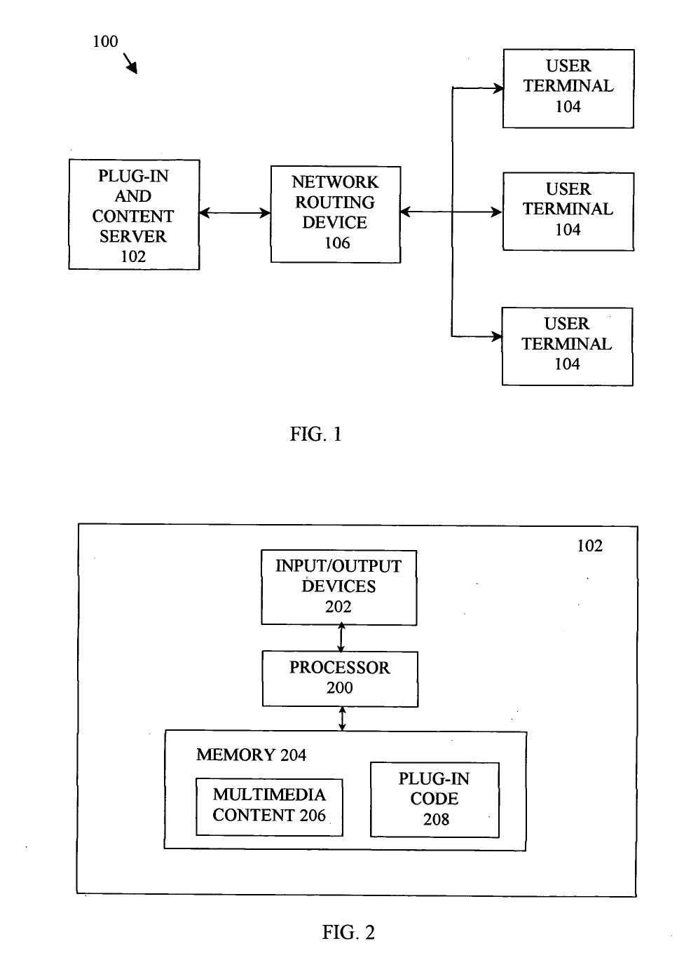

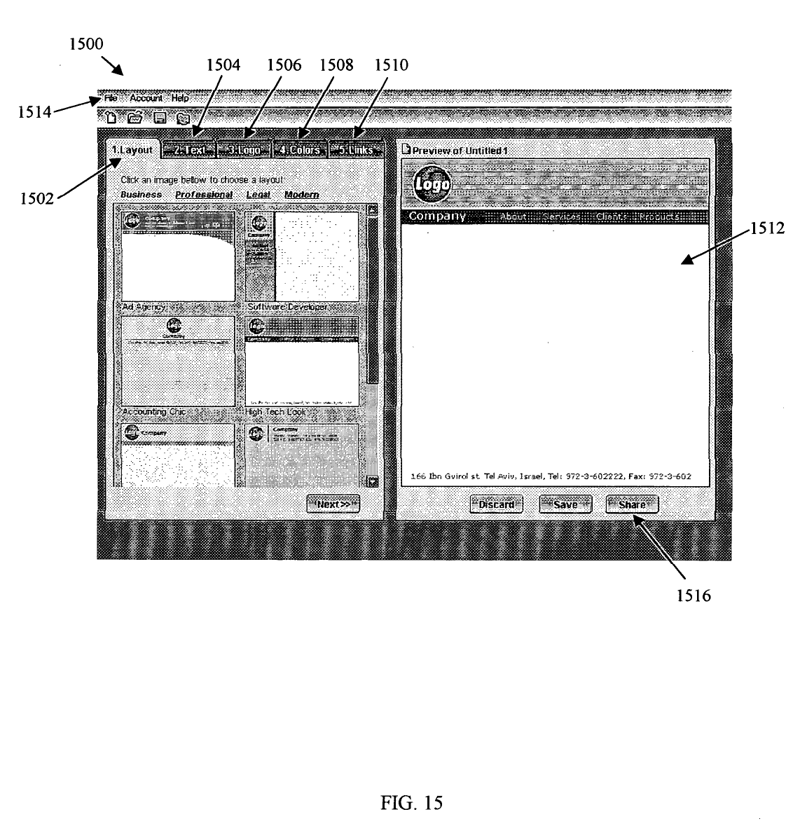

Referring now to FIGS. 1-22, wherein similar components of the present invention are referenced in like manner, preferred embodiments of a method and system for customizing electronic messages are disclosed.

Turning now to FIG. 1, there is depicted an exemplary network 100 over which certain embodiments of the present disclosure may be practiced. The network 100 may be any known computer, electronic, optical, telecommunications, wireless or satellite network, or any combination of these elements, useful for accomplishing data transmissions between, for example, two users at separate computer terminals. In certain embodiments, the network 100 may be a local-area computer network or wide-area computer network, a corporate Intranet, a public computer network such as the Internet or World-Wide Web, any other comparable computer networks, or any combination of the same.

In those embodiments involving multiple users in electronic communication over a commonly-accessible computer network, the network 100 may include a plurality of user terminals 104 in two-way communication with each other and with a central Plug-In and Content Server 102 (sometimes referred to herein as “content server 102 ”), via at least one network routing device 106. In such embodiments, the plurality of user terminals 104 may be any one or more known computing devices, such as a personal computer or workstation equipped with a modem or other similar network communication device, as are commonly manufactured by, for example, Dell Corporation® or Gateway Corporations. The network routing device 106 may accordingly be any one or more of the following devices: a computer server dedicated to routing communications data over a computer network, such as computer servers commonly manufactured by IBM Corporations®; and a computer network routing device or Internet router, such as those commonly manufactured by Cisco Corporation®. The Plug-in and Content Server 102 may, in such embodiments, be one or more computer servers operated by a content provider or group of content providers. The computer server(s) is/ are operable, via appropriate hardware and programming, to store and communicate both: (1) executable programming code or processing instructions for installing an access to content within an existing electronic message program on a user terminal 104 and (2) content to be accessed by the user after installation of the executable programmable code. Further descriptions of an exemplary Plug-In and Content Server 102 are provided later below in conjunction with FIG. 2.

In those embodiments where the network 100 is the Internet, each of the plurality of user terminals 104 and the Plug-In and Content Server 102 may have a unique network address, such as an Internet Protocol (IP) address. A user terminal 104 may be operable to communicate calls for content from an IP address of the Plug-In and Content Server 102. The Plug-In and Content Server 102 may be operable to store the IP address or, store or generate any other type of unique identifier, corresponding to a particular user terminal 104 that has accessed and installed the executable programming code. The Plug-In and Content Server 102 may store such a unique identifier in order to, for example, associate and store any configurations or preferences for content selected by the user, as described later below.

In alternate embodiments where network 100 is not a computer network, each of the Plug-In and Content Server 102, the plurality of user terminals 104 and the network routing device 106 may be substituted with similar devices that perform similar functions in the subject network environment. For example, in a cellular telephone communications network, the plurality of user terminals 104 may be cellular telephones, content server 102 may be a server maintained by a cellular telephone communication provider, and network routing device 106 may be a wireless antenna that routes cellular communications there-between. In another example where network 100 is a satellite network, each of Plug-In and Content Server 102 and the plurality of user terminals 104 may be computers and servers as described previously, and network routing device 106 may be a satellite transmitter/receiver. Likewise, in an optical network environment, the network routing device 106 may be one or more optical communication routers. Additional examples involving alternate network embodiments will be apparent to those of ordinary skill in the art, and are readily contemplated as being within the scope of the present disclosure.

Referring now to FIG. 2, there are depicted exemplary components of a Plug-In and Content Server 102. The content server 102 may include a processor 200, such as those commonly manufactured by Intel Corporation® or Sun Microsystems Inc.®, for executing machine-readable programming code, commands or processing instructions as described herein. Content server 102 may further include one or more input/output devices 202, which may be any known devices used for communicating over the network 100, such as a modem or similar computer communication device. The input/output devices 102 may also be any known device used for inputting programming commands from an operator of the content server 102, such as a keyboard, a computer mouse, or a speech-recognition device. The input/output devices 102 may further be any known device for displaying data to an operator of content server 102, such as a computer display.

The memory 204 may be any known device (1) for storing content data, such as multimedia content 206, and (2) for storing programming code, commands or processing instructions that are executable by the processor 200, such as plug-in code 208. Accordingly, memory 204 may be any one or more of the following: a random-access memory (RAM); a read-only memory (ROM); a Metal-Oxide Semiconductor (MOS)-based storage device such as a memory chip or a hard drive; a portable computer-readable medium, such as a floppy disk, a Compact Disc-Read Only Memory (CD-ROM), a Digital Video Disc-Read Only Memory (DVD-ROM); or any other known write-once or re-writable computer-readable medium or combination thereof

Multimedia content 206 stored by memory 204 may include data files that store content, which can be selected and inserted into an electronic message by a user. The content may be any of a variety of multimedia content readily available to current computer users, including: graphical images, scanned images, photographs, pre-formatted text, animations, audio content, audio/visual content and any combination or element thereof Graphical images may be provided in various data formats, such as, but not limited to: .GIF, .TIF, .BMP, and .JPG Animations may be provided in FLASH programming code or other similar formats. Audio content may be provided in, for example, .WAV or .MP3 formats. Audio/visual content may be of the type commonly available in .MPEG or similarly-functioning formats. The available content may be determined by a content provider maintaining the content server 102, or may alternatively include, separately or in addition thereto, content that is downloaded to the content server 102 by a user or stored locally by a user.

In certain embodiments, the plug-in code 208 stored by memory 204 provides a plug-in to an existing electronic message program on the user terminal 104. Since there are various existing electronic message programs that are already in vast world-wide use, the systems and methods disclosed herein have a greater potential to be widely adopted by users of such existing electronic message programs if a plug-in to such existing programs is provided, rather than attempting to introduce to the global market place a completely new electronic message program incorporating the systems and methods herein. The plug-in is additionally of a smaller size and thus more readily transmitted and installed than would be a completely new electronic message program.

It should be readily appreciated that content server 102 may be a single computer server, or may be any number of locally- or geographically-disperse servers that cooperate to perform the functions described herein. The executable code and data described here as stored by the content server 102 may be stored in any manner among a cooperating group of content servers 102, and may or may not be stored in the same memory 204 as depicted in FIG. 2. It should be further appreciated that the content server 102 may, in certain embodiments, be operated by a content-providing business entity, an agent of such a content provider, or any other operator who maintains the systems and performs the methods described in the present disclosure.

It should likewise be readily appreciated that the user terminals 104 mentioned previously may contain similar hardware components that were described above with respect to the content server 102.

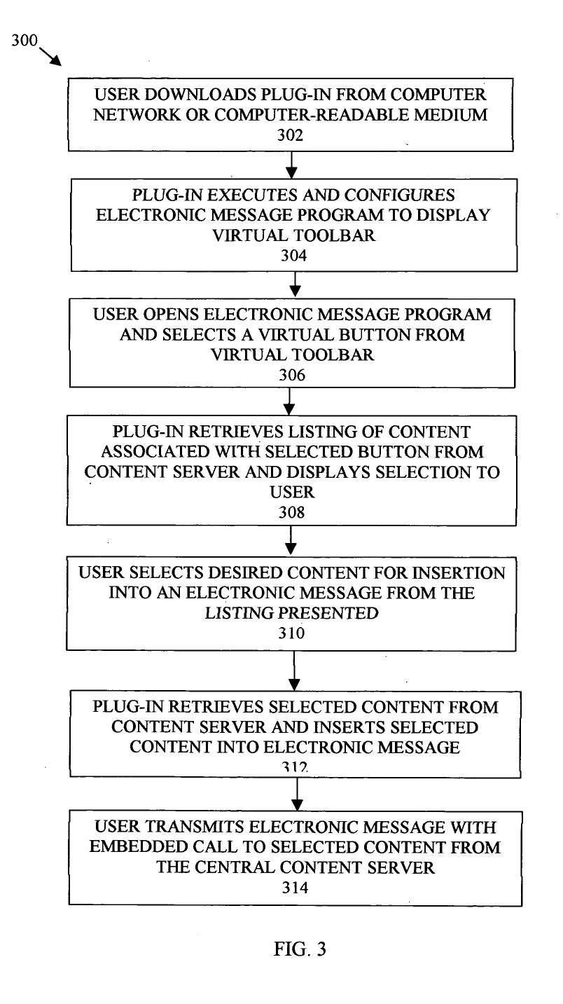

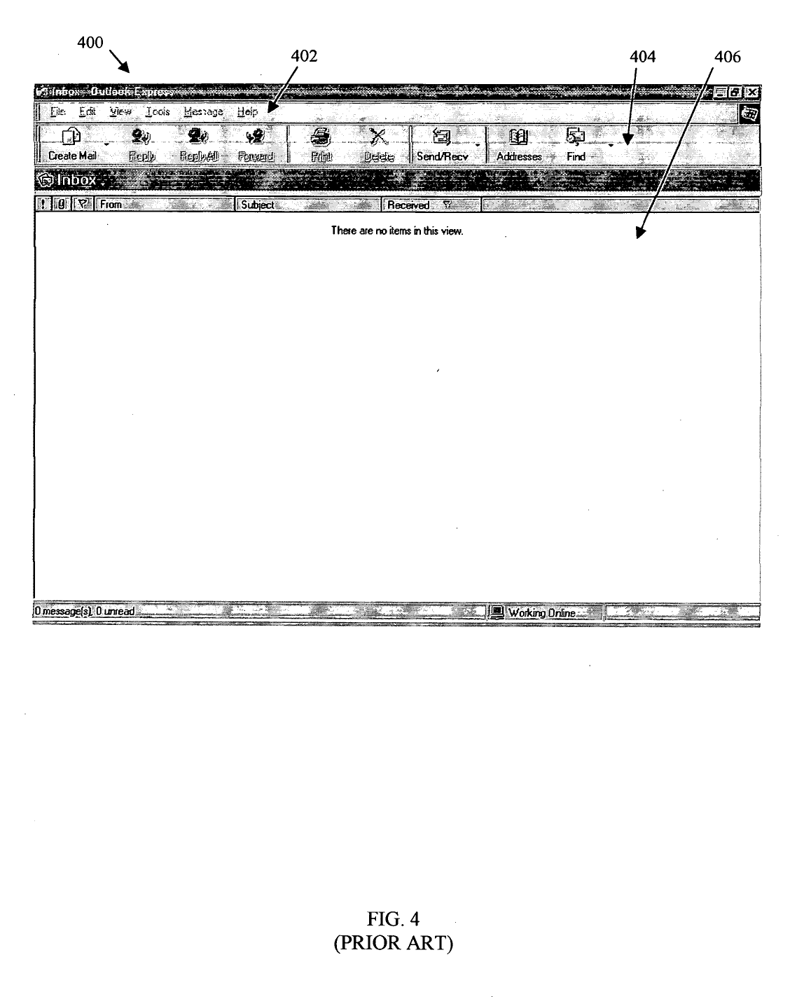

Turning now to FIG. 3, in conjunction with particular references to FIGS. 4-11, there is depicted an exemplary process 300 for customizing an electronic message according to certain embodiments of the present disclosure. In the context of a computing network 100 as described with respect to FIGS. 1 and 2, the process 300 commences when a. user operating a user terminal 104 accesses and downloads the plug-in code 208 from Plug-In and Content Server 102 (step 302). For example, the plug-in code 208 may be retrieved from a publicly accessible IP network address (i.e. a web page on a web site) over the Internet. The download of the plug-in code 208 may be requested by a user or may be automatically transmitted to a user terminal 104 upon its accessing of the content server 102.

Next, the downloaded plug-in code 208 is installed on the user terminal 104 (step 304). It may then be executed by a user, or may be provided with automatically-executing processing instructions, to reconfigure an existing electronic message program on the user terminal 104. In particular, the electronic message program may be reconfigured to display a new virtual toolbar 600 therein.

A comparison of in FIGS. 4 and 5 to FIGS. 6 and 9, respectively, will provide one example of how an electronic message program may be reconfigured by the plug-in code 208 according to step 304. A main window 400 of an existing message program of the prior art is displayed in FIG. 4. Prior to any installation of the plug-in code, the main window 400 may contain: a native menu bar 402 for accessing menus of native programming commands relating to the electronic message program; a native toolbar 404 for selecting native functions of the electronic message program; and a message pane 406 for listing, inter alia, any received electronic messages.

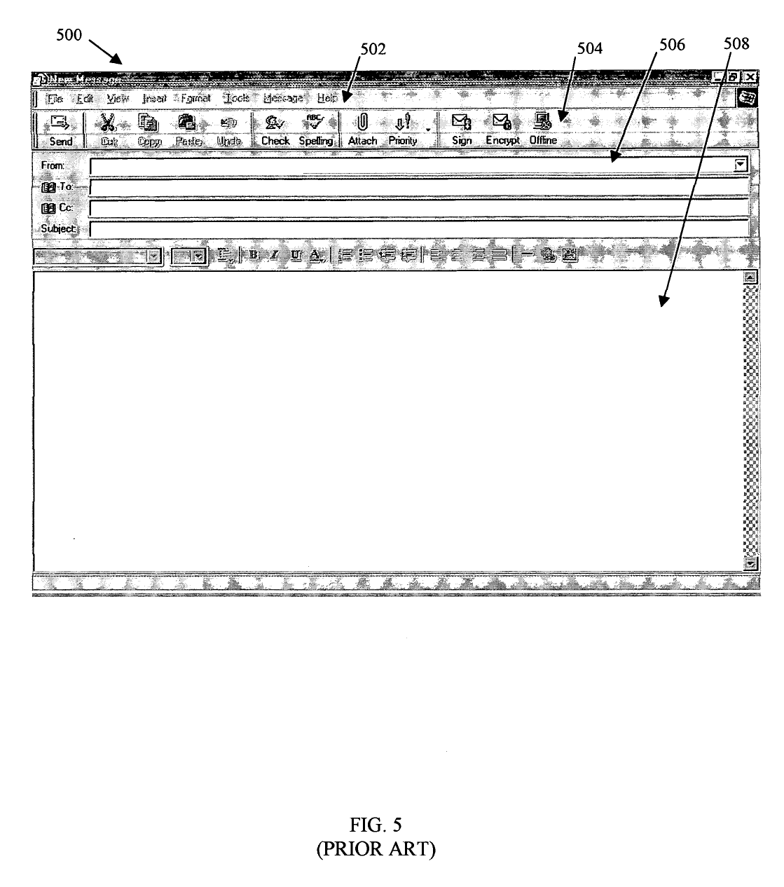

When a user creates a new message using the existing electronic message program, a new electronic message window 500 is generated, an example of which is displayed in FIG. 5. Prior to installation of the plug-in code 208, the electronic message window 500 may contain: a native menu bar 502, a native toolbar 504, a number of message recipient address and message subject fields 506, and a message input field 508.

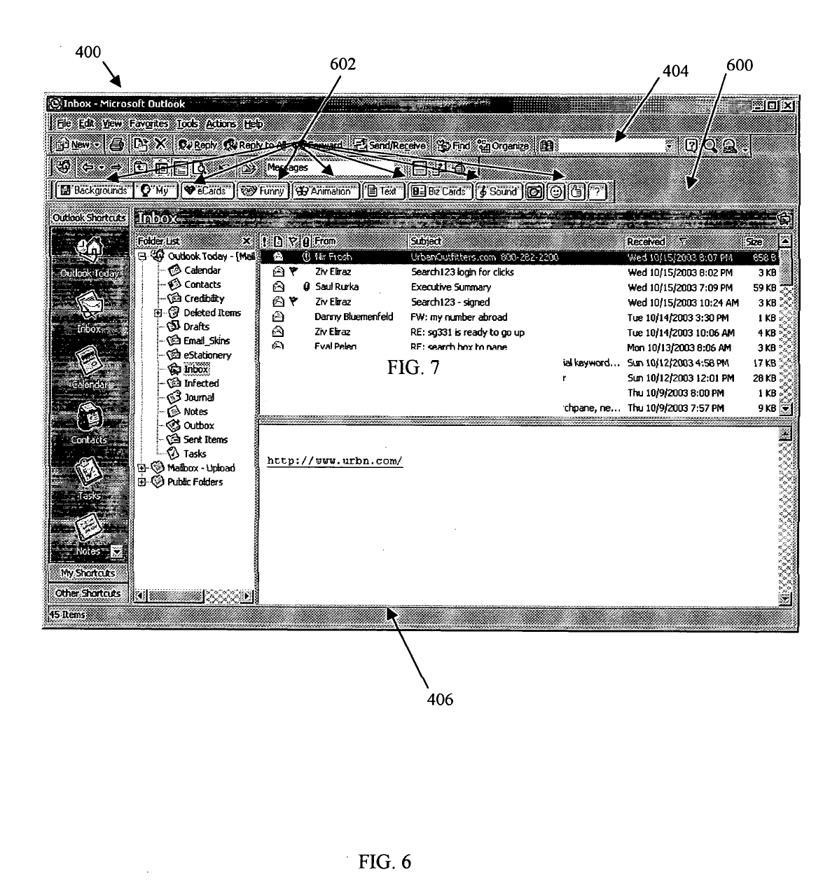

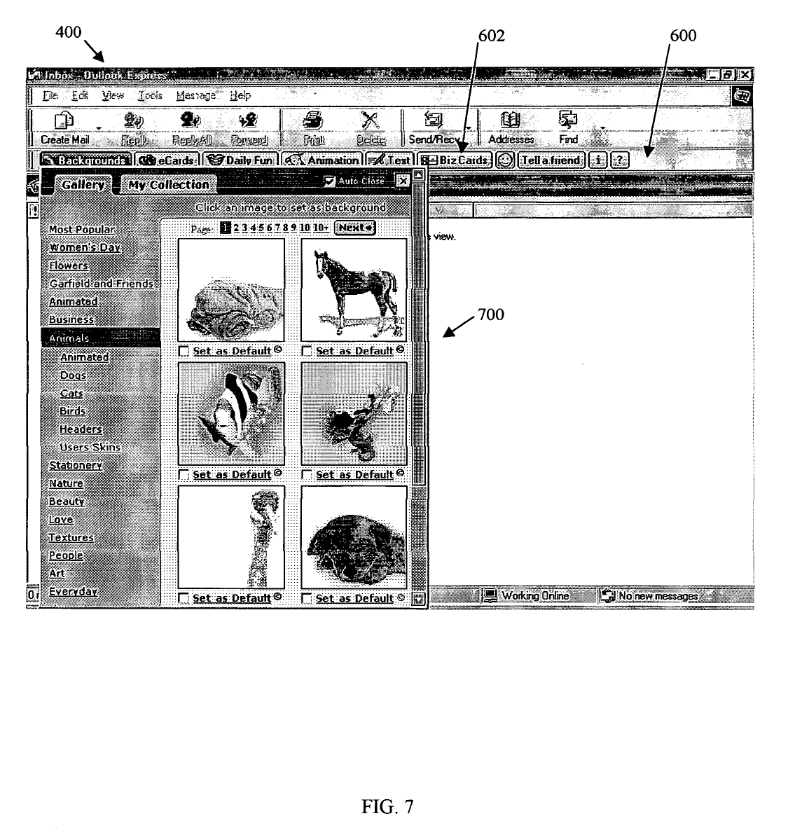

After installation of the plug-in code 208, the main window 400 and the electronic message window 500 may be reconfigured by the plug-in code 208, as displayed in FIGS. 6 and 7 respectively. As shown in FIG. 6, the main window 400 has been re-configured to include a virtual toolbar 600 containing one or more virtual buttons 602, wherein when a user selects a virtual button 602, a window is presented that shows associated selectable content that is available for insertion into an electronic message.

In certain embodiments, the virtual toolbar 600 may be disposed between the native toolbar 404 and the message pane 406. The insertion of the virtual toolbar 600 at this location in the main window 400 provides a convenient and readily-accessible place for a user to select and access available content using stationery creator features. In further embodiments, the toolbar 600 may be provided in alternate useful locations within the main window 400, or even outside the main window 400 on a user terminal's display. Alternatively, or in addition thereto, one or more virtual buttons may be displayed within a native toolbar 404. Nothing in FIG. 6 should be considered to limit the shape, appearance, configuration or the like of the virtual toolbar 600 or the virtual buttons 602 themselves (including the number or any attributes of the virtual buttons 602), or the particular attributes of the main window 400.

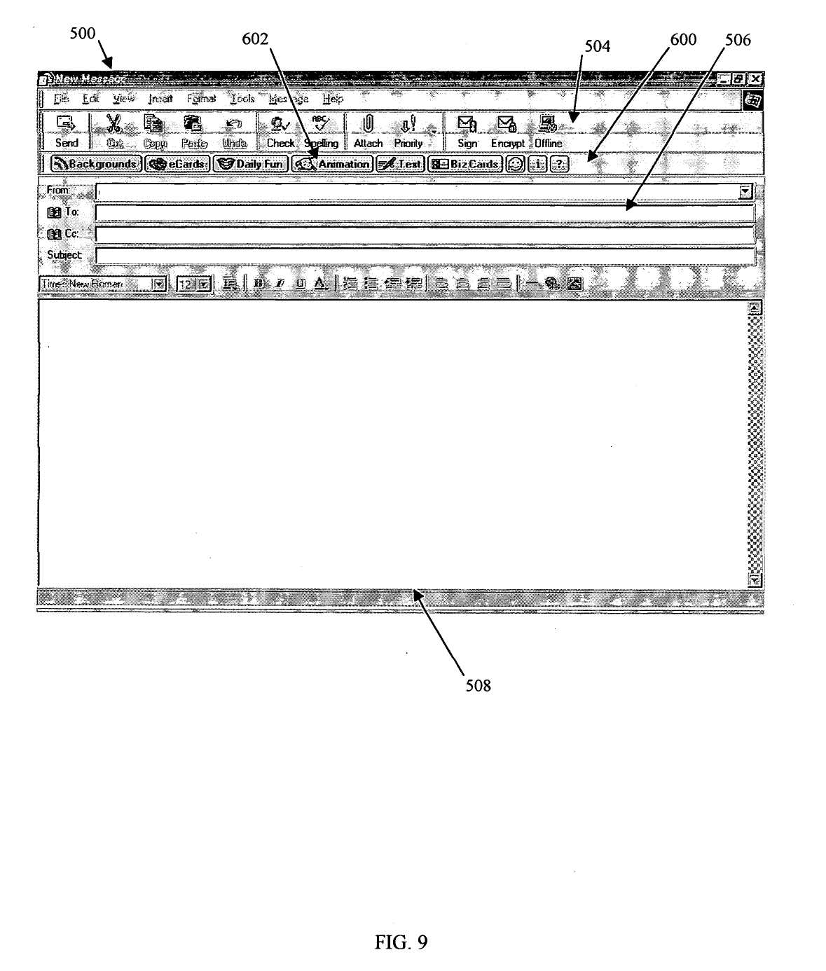

The electronic message window 500 may be similarly reconfigured as described above with respect to FIG. 6. One example of the results of such reconfiguration is shown in FIG. 9, wherein the virtual toolbar 600 is displayed to a user. In certain embodiments, the virtual toolbar 600 may be disposed between the native toolbar 504 and the message input field 508. The virtual toolbar 600 may also be disposed between the native toolbar 504 and the message recipient address and message subject fields 506. The insertion of the virtual toolbar 600 at such locations in the electronic message window 500 provides a convenient and readily-accessible place for a user to select and access available content.

In further embodiments, the virtual toolbar 600 may be provided in alternate useful locations within the electronic message window 500, or outside the electronic message window 500 on a user terminal's display. Nothing in FIG. 9 should be considered to limit the shape, appearance, configuration or the like of the virtual toolbar 600 or the virtual buttons 602 themselves (including the number or any attributes of the virtual buttons 602), or the particular attributes of the electronic message window 500.

The manner in which such reconfigurations of the main window 400 and the electronic message window 500 are achieved is largely dependent on the existing electronic message programs being used by a user terminal 104. For example, where the existing electronic message program is any of the various versions of Microsoft® Outlook®, such reconfiguration may be accomplished in accordance with the _IDTExtensibility2 interface implementation published by Microsoft®. A Common Object Module (COM) object is registered by the plug-in code 208 with the Outlook® program. The COM object generates a call including a bootstrap parameter that enables recognition by the Outlook® program for certain plug-in code relating to the attributes and location of the virtual toolbar 600.

Where the existing electronic message program is any of the various versions of Microsoft® Outlook Express®, such reconfiguration may be accomplished in a slightly different manner, since Outlook Express® does not readily provide for add-on programming, particularly third-party add-ons by a different manufacturer. In this case, a standard announced by Microsoft® called hooking may be employed. The standard includes programming “hooks” that allows detection of window events and process crossings initiated by the electronic message program and further allows redirecting native commands to new code. When a new window-creating event for the Outlook Express® program is detected by the plug-in code 208, a bootstrapping of the new code corresponding to the virtual toolbar 600 and virtual buttons 602 is inserted into the event for providing the virtual toolbar 600 and virtual buttons 602 within the main window 400 and the message window message 500. Such bootstrapping may be accomplished using known sub-classing techniques for planting new code in the electronic message program as described above.

Similar techniques can be employed for other existing electronic mail messaging programs, such as LotusNotes® by IBM Corporation®. Use of such similar techniques will be largely dependent on the methods of interacting with native programming instructions provided by such programs' manufacturers.

Returning to process 300, after step 304 above, the user may open or initiate the electronic message program, which now includes the virtual toolbar 600, and selects a virtual button 602 from the virtual toolbar 600 that corresponds to particular content, or categories of content, for insertion into an electronic message (step 306). The virtual buttons may include a brief description of a category of content associated with the virtual button 602. Such title on the virtual button may be changed from time to time by the content server 102, and in certain embodiments, without initiation of any commands by the user. Such selection may be performed by a user on user terminal 104 by placing a display cursor over the virtual button 602 and depressing a key on a computer mouse. Upon selection of the virtual button 602, the installed plug-in retrieves a listing of content associated with selected button from content server 102 and displays the available selections to the user (step 308). The displayed listing(s) may be retrieved by the installed plug-in by accessing a web page or the like of the content server 102 over the computer network 100. The web page may contain hypertext links or the like to network address of data files containing the selected content for display to the user in a generated electronic message.

In certain embodiments, the listing may be displayed to the user in a separate content window 700, as shown in FIG. 7. The separate content window 700 may be generated using hyper-text mark-up language (HTML) commands, JAVASCRIPT commands, or the like. The separate content window 700 may include one or more categories (i.e. background art, holiday-themed formats, humor, animations, and business-formatted content) and subcategories (i.e. animal images, nature images, and the like) of available content. Thumbnail images of the content may be displayed in the content window 700. There may also be commands available that allow a user to select particular content as default content for a future electronic message. As mentioned previously, since the content window 700 may contain links to pages of content available on content server 102, and since the data files containing the content may reside exclusively on the content server 102, the content server 102 may update its own pages of content without having to further reconfigure the native programming code of the existing message program or the installed plug-in code. In addition, the amount of stored content is, thus only limited to the available memory space in content server 102, rather than the typically more limited amount of memory space in a user terminal 104. Alternatively, users may store available content locally on their user terminal 104 or may even upload additional content to the content server 102 for later access by the user and/or additional users.

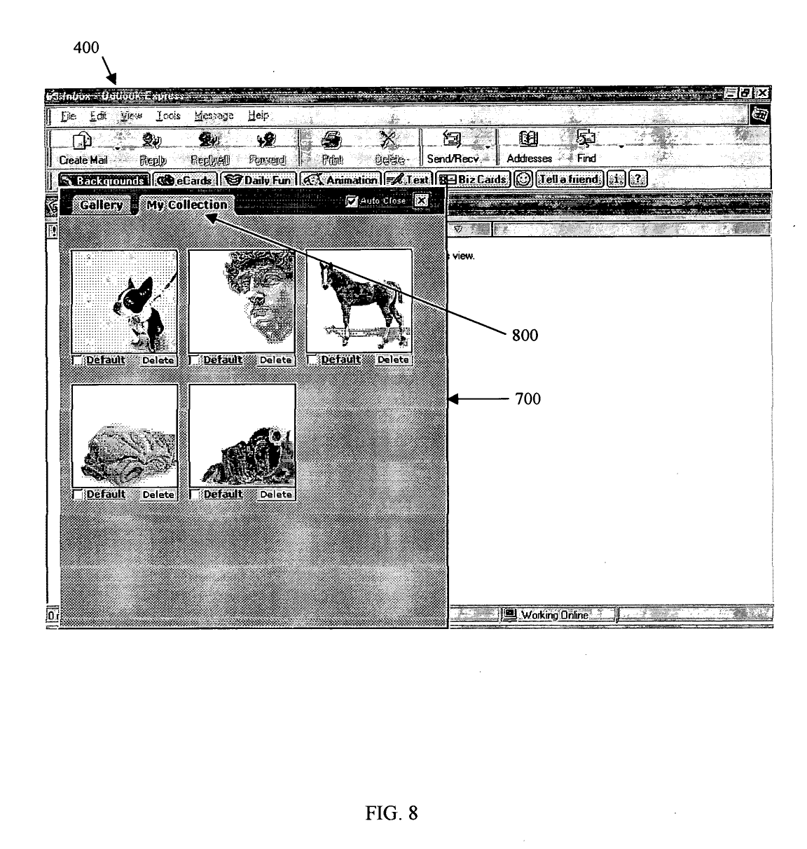

The content window 700 may also include hypertext links to additional content or tabs corresponding to further listings of available content. An example of the results of a selection by a user of one of the hypertext links or tabs in content window 700 is displayed in FIG. 8, wherein further selections of content may be provided.

It should be noted that, with respect to step 308, the virtual button 602 may be selected from the main window 400 or the electronic message window 500. In the former case, the selection of the virtual button 602 from the main window 400 may initiate the opening of a new electronic message window 500 and the content window 700 corresponding to the selected virtual button 602, as shown in FIG. 9.

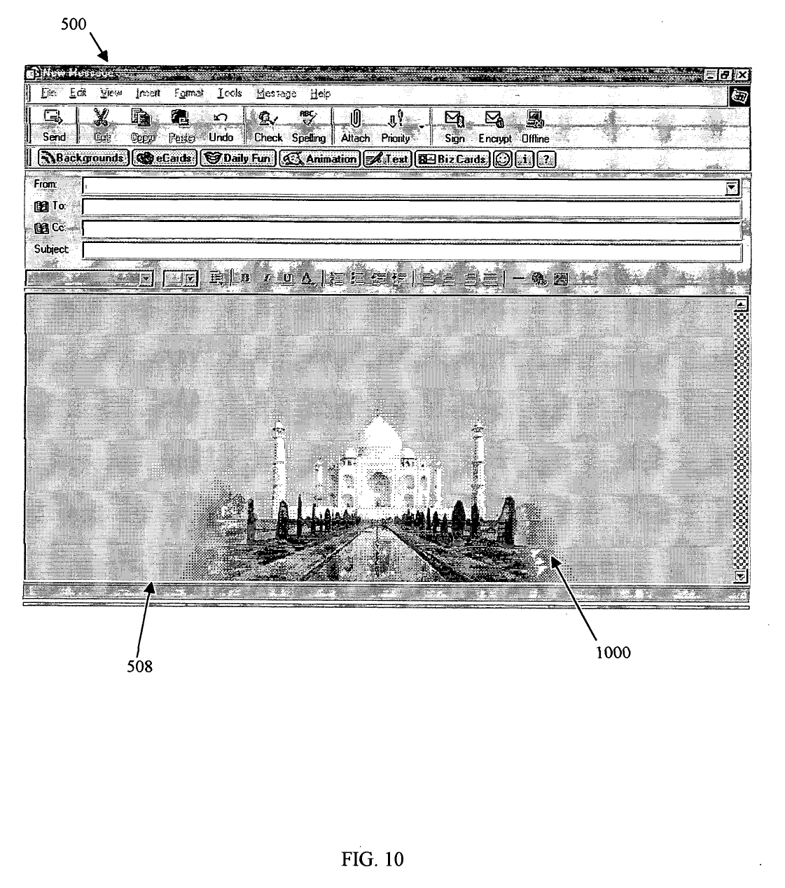

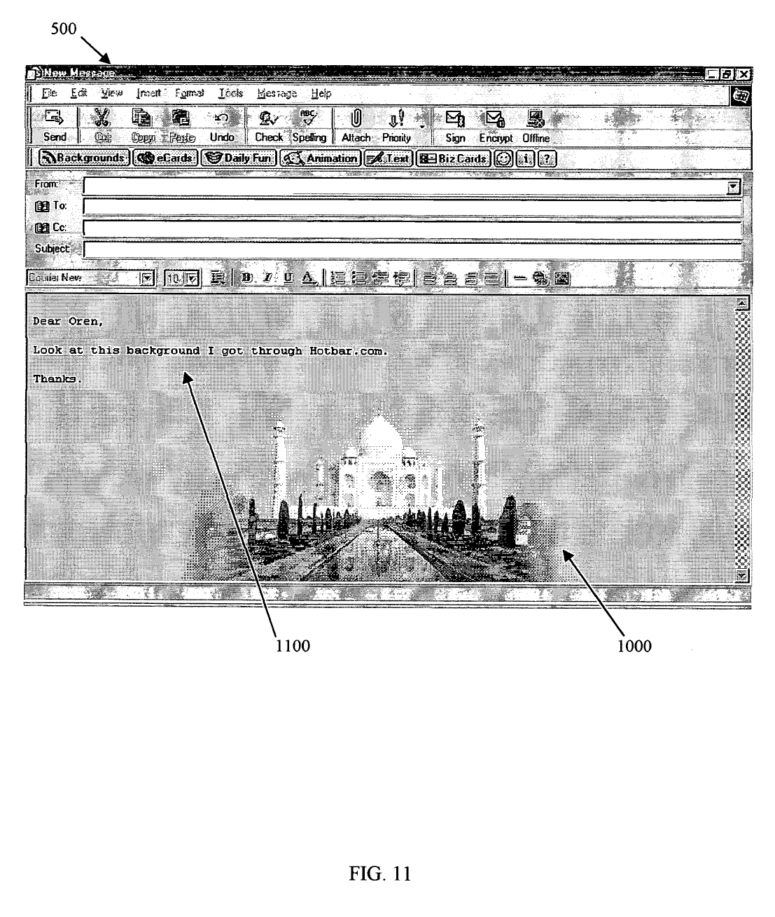

Returning again to process 300, after the content window 700 is displayed to the user, the user may select desired content for an electronic message from the displayed listing (step 310). The user may also select particular content as default content, if desired from the content window 700. Upon the selection of any type of content, the installed plug-in retrieves the selected content from the corresponding network address on the content server 102, and further inserts the selected content into the electronic message 500 for display to the user (step 312). One example of the results of this step 312 is shown in FIG. 10, wherein selected content 1000 is displayed to the user in the message input field 508 of the electronic message window 500. The user may then input desired text 1100, using a keyboard or the like, into the message input field 508 which may be displayed in conjunction with the selected content 1000, as shown in FIG. 11.

The manner in which retrieval and display of the selected content 1000 is accomplished is dependent upon the type of existing electronic message program in use. Reference is now made to an IHTMLDomDocument (or inspector HTML) interface published by Microsoft®, which is necessary for its electronic message programs to read and edit HTML-based content and is utilized in accordance with various embodiments of the present disclosure.

Where the electronic message program maintained by a user is Outlook®, the plug-in code described herein may retrieve a current active Inspector (or mail window) object in accordance with the above-mentioned published interface. This object has an established function called GetDocument, which provides the necessary inspector HTML Dom Document. Where the electronic message program is Outlook Express®, the installed plug-in code retrieves HTML content by providing appropriate processing instructions via a document container, in accordance with the accessibility software module provided for that program. In either case, the retrieved HTML content may provide both the accessible content and the virtual tool bar 600 of the present disclosure within the user's electronic message program.

Insertion of the selected content 1000 into an electronic message is accomplished using a mail editing module that is commonly provided to Outlook® and Outlook Express®. The IHTMLDomDocument interface enables the installed plug-in code to construct the HTML content within the message input field 508. The user may add desired text 1100 in any standard manner, in accordance with the native processing instructions provided by the electronic message program.

Finally, returning to process 300, the user may transmit the electronic message to a second user on a second user terminal 104 (step 314), after which the process 300 ends. Since some data files of content may be large in size, it may be desirable, in certain embodiments, to limit the size of the message transmitted in step 314. This can be accomplished, in various embodiments, by transmitting an embedded call to the selected content on the content server 102, rather than including the data file of the content itself Upon opening the electronic message, the second user may open the received message, after which the embedded call is activated, and the selected content 1000 is uploaded for display to the selected user, along with any desired text 1100 in the received electronic message. Since the call is embedded in the electronic message by the user on the first user terminal 104, it should be readily appreciated the second user need not install the plug-in code 208 to view the content in the received message. It should also be readily appreciated that once a user installs the plug-in code 208, it is not necessary to re-install the plug-in code 208 for each successive electronic message generated. That is, steps 302 and 304 may be omitted when content is to be inserted in future electronic messages after the plug-in installation has been completed.

In various embodiments of the present disclosure, a content provider operating content server 102 may be able to raise revenue from a group of users using the processes described above. The revenue may be generated via advertising presented to the user during any of the steps of process 300. A plethora of methods for accomplishing the presentation of advertising is well known in the context of public computer networks, all of which are contemplated to be within the scope of the present disclosure. In addition, advertising revenue can be had by providing additional plug-ins to other types of computer programs, such as web browsers, along with the plug-in for the electronic message program described above. Advertising may then be displayed upon use of such other plug-ins by the user. Such additional program plug-ins are described in co-pending U.S. patent application Ser. No. 09/864,551 entitled SYSTEM AND METHOD FOR THE DYNAMIC IMPROVEMENT OF INTERNET BROWSER NAVIGABILITY filed in the name of Dobronsky et al. on May 23, 2001 which is a continuation in part of co-pending U.S. patent application Ser. No. 09/373,815 entitled SYSTEM AND METHOD FOR THE DYNAMIC IMPROVEMENT OF INTERNET BROWSER APPEARANCE AND CONNECTIVITY filed in the name of Dobronsky et al. on Aug. 13, 1999, each of which are incorporated herein by reference. In addition to, or in conjunction with advertising, a content provider may also generate revenue by charging subscription fees to users wishing to access the content.

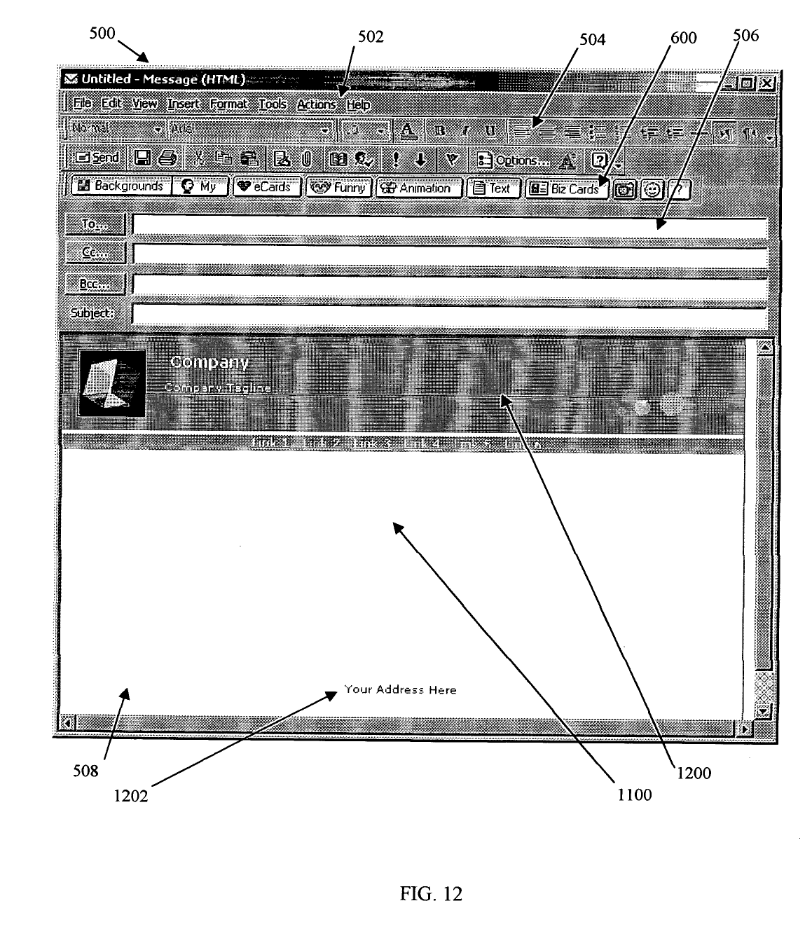

Revenue may also be generated by providing design services to users for generating customized content that is accessible to a particular user or group of users paying for such services. For example, one contemplated feature of the present disclosure is providing business-formatted content for insertion into an electronic message. General business-formatted content can be provided to all users. However, customized business message formats and associated designs may be developed by the content provider specifically for a single business entity, in exchange for a fee. Installation and updating of customized message formats may be accomplished in a similar manner to those described above, or in any other useful manner. The developed content may include corporate logos, trademarks, company information, general corporate contact information, stationary designs, business card designs for particular employees and agents of the business entity, promotional materials, advertising and particular formats for internal and external electronic messages, including pre-formatted locations for desired text 1100 inputted by the business entity or its agents. An example of customized business-formatted content is shown in FIG. 12, including custom developed content 1200, pre-formatted text 1202 and pre-formatted location for inserting desired text 1100.

In other additional embodiments of the present disclosure, the installed plug-in code may further include processing instructions allowing for the attributes of the virtual toolbar 600 and virtual buttons 602 to be changed by accessing new formats and attributes automatically from the content server 102 whenever a user's reconfigured electronic message program is initiated. In this manner, it is not necessary for a user to perform any steps to receive updates to the installed plug-in code. In a particular embodiment, no user action is required in order for them to receive updates to either accessible content or the virtual menu bar including the virtual buttons. For example, where a virtual button is identified as having content associated with an upcoming holiday, once that holiday passes and a new holiday is approaching, the content server 102 may automatically access and change the name of the button when the electronic message program is open. The web page of associated content maintained by the content server may likewise be updated to include different content dedicated to the upcoming holiday without user interaction.

In further embodiments of the present disclosure, the plug-in may provide various tools, collectively referred to herein as STATIONERY CREATOR (SC) tools, that allow a user to generate, store, share and manage customized templates for electronic messages. The SC tools are beneficial for both ordinary users and small business users. For the latter in particular, the SC tools provide functions to generate interactive templates including commercial promotions or the like. Such stationery templates may thus be used to increase a company's brand awareness, drive Website traffic, and promote products or services.

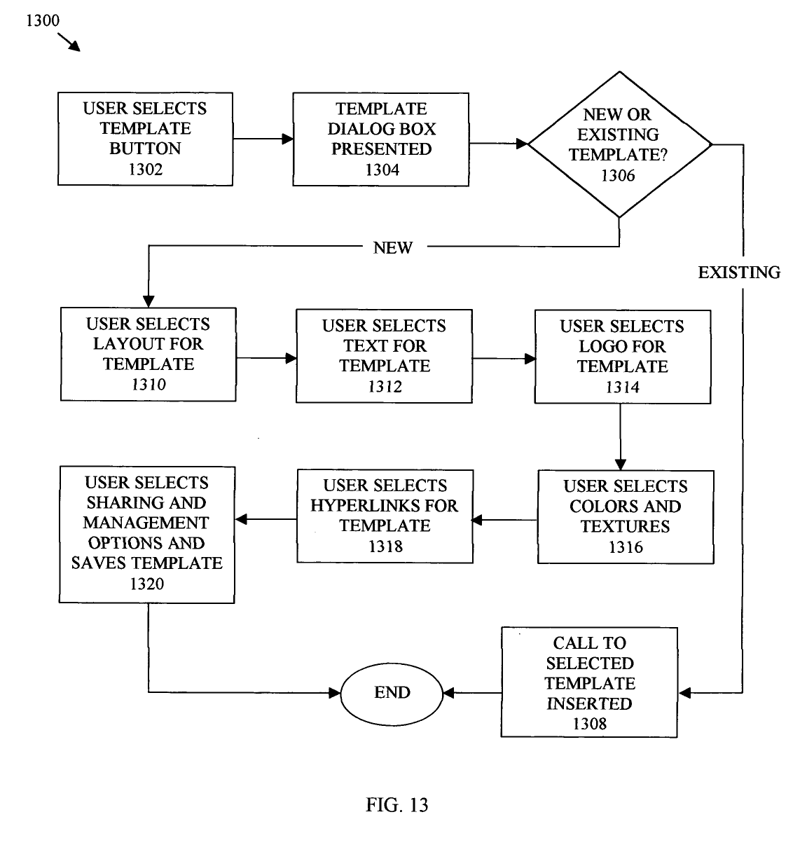

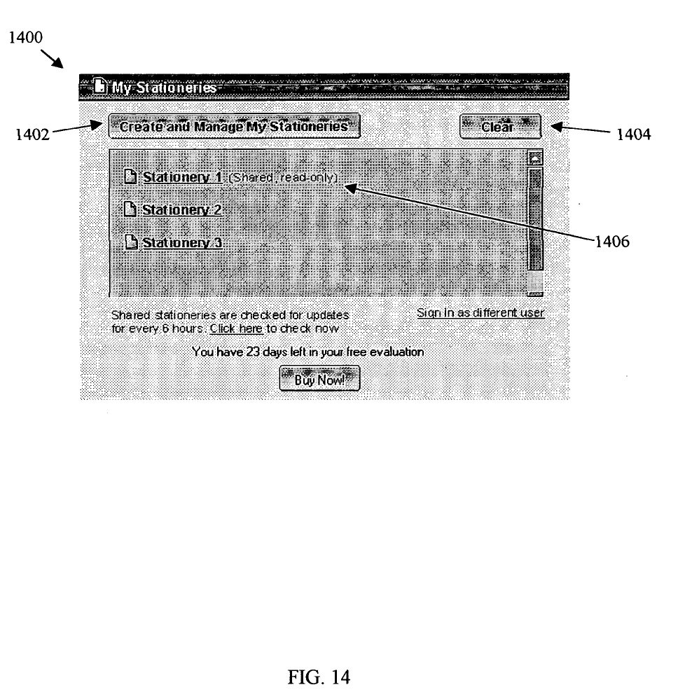

Turning now to FIG. 13, and with continuing reference to FIGS. 14-22, an exemplary process 1300 for generating a customized electronic message template is illustrated. The stationery creator functions presented herein are flexible and can be used in any order the user chooses. The exemplary process 1300 commences when a user selects a virtual button (i.e. a “My Stationeries” button) dedicated to accessing customized message templates that are provided by the plug-in via the virtual toolbar 600 (step 1302).

If the user has previously created an account, has used the SC tools or has existing saved or shared templates, the process 1300 continues to step 1304 described later below. If the user has never accessed the SC tools and does not have any stored or shared templates, the user may be invited to create an account, purchase the SC tools or access the tools on a trial basis, as described below.

A user may be allowed to use the SC tools without purchase in any of the following three manners:

First, the content server 102 may provide a new user with a time-limited evaluation in which access to the full version of the SC tools is provided for a limited time. After the trial period (for example, one month) access to the SC tools are blocked, and the user is provided with a reminder to purchase the SC tools and a link to web site in which the purchase may be completed.

Alternatively, the content server 102 may provide a new user with a time-limited or unlimited evaluation period in which access is provided to the full version of the SC tools, but with a promotional attachment by which a commercial promotion and/or a hyperlink appears within each electronic message having a customized template that is generated by the user. The user can remove the promotional links only after purchasing the SC tools. After a limited trial period expires, access to the SC tools and templates is likewise blocked, and the user is provided with a reminder to purchase the SC tools.

After selection of the virtual button in step 1302 above, the process 1300 continues to step 1304 wherein an initial customized message template window 1400 is presented to the user. An exemplary initial window 1400 is displayed in FIG. 14. The initial window 1400 may include a “create and manage templates” button 1402 for generating a new message template or managing stored templates. A “clear” button 1404 is provided to allow a user to create a new electronic message without a message template.

A list 1406 of existing customized message templates previously used or generated by a user is also presented in the window 1400. The list 1406 may indicate whether a template is shared with and/or editable by other users. Clicking on the link may open the template and may further cause the plug-in to check if there are updates to any other stored templates, which are then updated if necessary.

In certain embodiments, the last template used is automatically set as the default message template for any new electronic message generated by the user. The user may likewise be allowed to designate a default template other than the last template used.

The initial window 1400 may further include a “buy now” button 1408 that directs the user to a web site where the SC tools may be purchased. If, for example, the user's trial period has ended, the initial window 1400 described herein is instead replaced with a message informing the user that the trial has ended, and a link to purchase the SC tools.

The initial window 1400 may finally include any number of additional functions, such as allowing a user to sign on as a different user.

Returning to the process 1300, the user next decides whether to select an existing listed template or to create a new template (step 1306). If the user selects an existing template, the process 1300 continues to step 1308, immediately below. Otherwise, the process 1300 continues to step 1310, described later below.

Clicking on a hyperlink to an existing template, for example, in the list 1406, creates a new electronic message window in which a programming call to the selected template is saved (step 1308). The programming call functions as described previously. Thus, if the user is offline when the selection is made, the user will be presented with a message indicating that she must be online to access the selected template.

If the user has selected an existing template that was previously edited, then all of the fields in the template will be populated with the updated data. Such data may include previously selected text fields, colors/textures, fonts, sizes, and layouts that may be defined by a user or another user, as described later with respect to the process 1300. The selected template is then presented to the user within the new electronic message window, after which the process 1300 ends.

Returning to step 1306 of the process 1300, if the user wishes to create a new customized message template, the user may select the “create and manage templates” button 1402. The process 1300 then continues to step 1310 where the user is presented with a template layout window 1500 for selecting a layout scheme for the new template.

The template layout window includes a layout tab 1502 for selecting or returning to the template layout window 1500. The window 1500 may further include a text tab 1504, a logo tab 1506, a colors tab 1508 and a links tab 1510, the purposes of which are to view windows for entering further message template attributes, as described later below with respect to steps 1310-1320. The tabs 1502-1510 may be programmed in HTML. All of the titles for the tabs 1502-1510 may be in text, and may be easily modified to show foreign languages for international use.

The template layout window 1500 may also include a message template preview pane 1512 for previewing a current version of the message template being generated, including all user-selected attributes.

A menu bar 1514 may be included to provide the following functions to a user: a command to create a new template, a command to delete a template, a command to rename a template, a command to edit a template, a command to share a template, and commands to change account details. The menu bar 1514 may be available no matter which of the tabs 1502-1510 are selected by a user.

A “share” button 1516 may be presented within the window 1500 to allow the user to share the template being generated with other users of the SC tools. If the user clicks on the share button 1516, a new electronic message opens with a link to the shared template. When this message is transmitted to a recipient, and the included link is selected by the recipient, the recipient's plug-in adds the shared template to the recipients template list, and if necessary, provides the recipient a link to download the plug-in from the content server 102 when the recipient is not a current user. A recipient that is not a current user may click the download button and the plug in will be installed automatically. The transmitted link may include a single-use identifier so that recipients cannot simply replace the identifier in the link and access other users' templates without authorization.

A list of thumbnails of available templates are shown in a simplified category tree within the layout selection window 1500. When a layout thumbnail is clicked, its preview appears in the template preview pane 1512. The layout thumbnails are organized according to category. The layout selection window 1500 may include any number of categories, e.g. “Legal,” “Real Estate,” “Hotel,” “restaurant,” or any other appropriate categories. When a category is clicked, stored thumbnails for the templates in that category appear.

Each sample layout template has the following editable parameters: a title of the template, a number of text fields for the template, any text to be included within the text fields, titles for each text field, font attributes (font type, style, size and color) for each text field, any logos, slogans or designs to be included in the template, template background and element colors, background template textures, any hyperlinks to be included in the template or with the selected logos, and any bullets or buttons to be associated with such hyperlinks.

These parameters will be automatically parsed from the generated template and will populate any stored SC database fields corresponding to the user's template with the selections, as entered by the user in the following steps 1312-1318.

If the user has edited the layout template, the layout will change and the parameters will be stored, upon direction by the user. If there are less text fields or logos available for editing in the changed layout, then the extra text fields and logos may be locally saved in memory during a template generating session, in case the user further changes the layout to include the extra data. Upon ending the session, however, these extra fields will not be saved. The user may be prompted to save any changes prior to using a template, or may use save and delete buttons for saving and deleting a template provided within the layout selection window 1500 as desired.

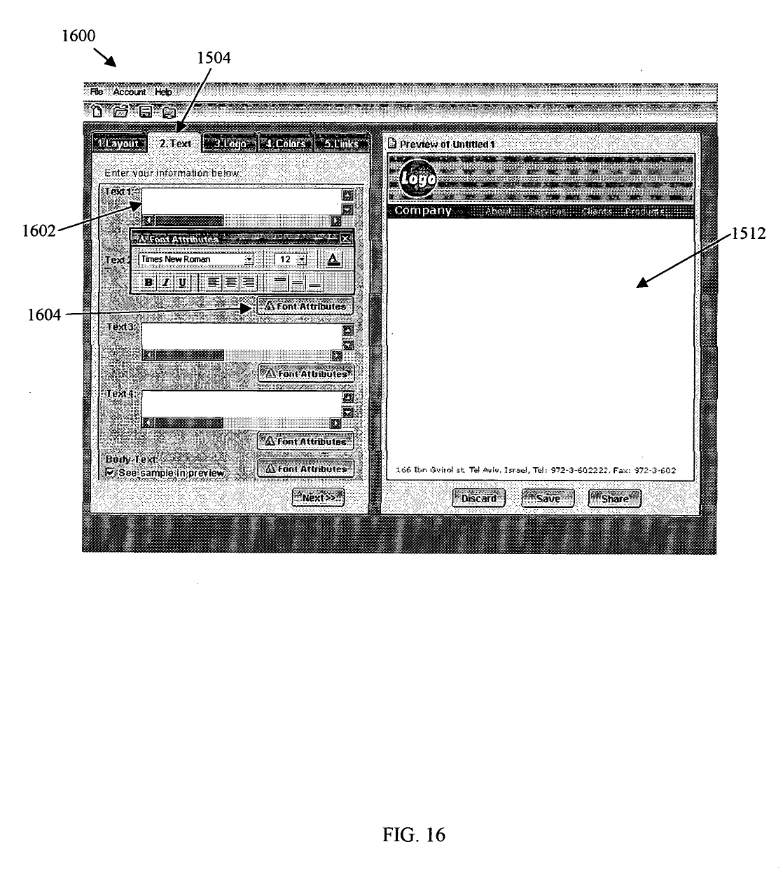

After selecting a layout for a new template, and upon selecting the text tab 1504, the user is next presented with a text selection window 1600, an example of which is displayed in FIG. 16. The text selection window 1600 allows a user to enter text into one or more text entry fields 1602 for insertion within the template (step 1312). The text entered in the text entry fields 1602 may appear in all electronic messages that use the template. Message text may later be added to any individual electronic message having the template in a standard manner. In the case of entered message text, the background and template data may be deleted or otherwise obscured behind such message text in order to facilitate printing and viewing of the entire electronic message. Any number of fields 1602 may be provided, dependent upon the design and size of the template being generated. Each text entry field 1602 may also have a title.

The text that the user enters in fields 1602 is regular text and not HTML. When a “font attributes” button 1604 is clicked, a window appears that is populated with the font attributes of that text entry field 1604. This font attributes window allows the user to select a new typeface, style, size, alignment, and color for the text entered in the respective field 1604. Font colors may be selected from a separate color palette window 2100, an example of which is shown in FIG. 21, upon selection of a change in font color.

As the user enters text or modifies the font attributes, the entered changes appear automatically in the template preview pane 1512.

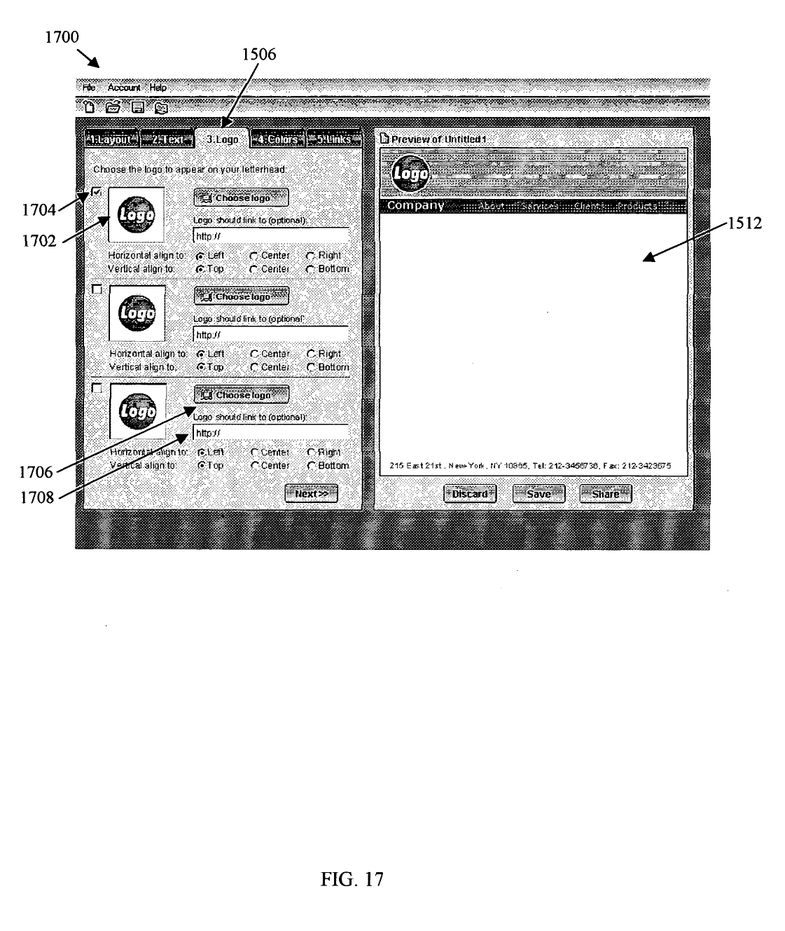

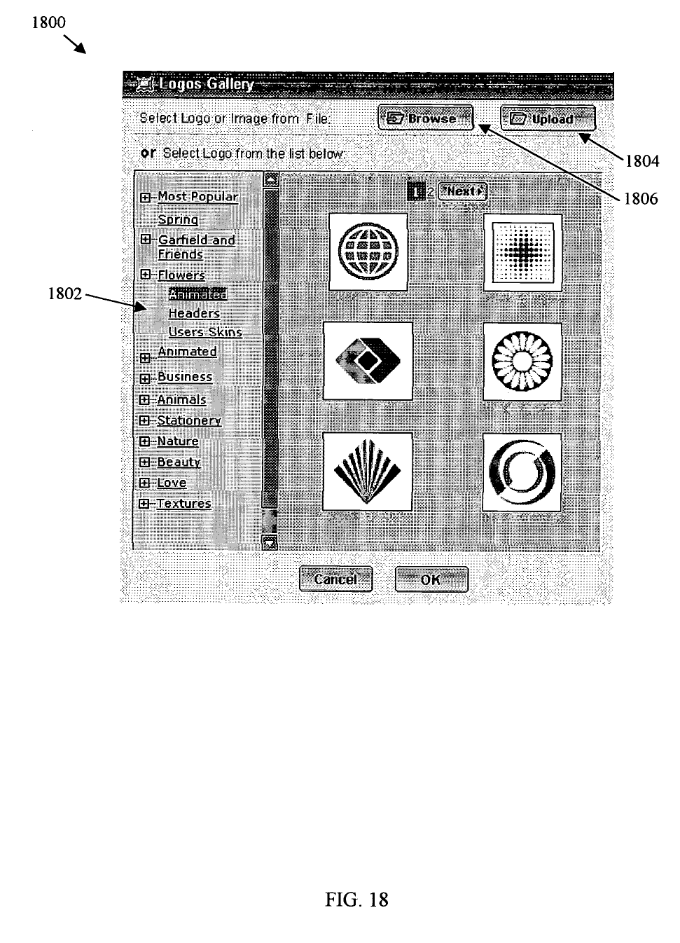

After text has been entered into the new layout template, and upon selecting the logo tab 1506, the user is next presented with a logo selection window 1700, an example of which is displayed in FIG. 17. The logo selection window 1700 allows a user to select an existing logo or upload a logo for insertion within the new template (step 1314).

Logo preview panes 1702 may be provided within the window 1700. Multiple logos may be included within a template. A logo selection check box 1704 for each available logo may be provided, the selection of which indicates that the logo in the corresponding logo preview pane 1702 is to be included within the new template.

A “choose logo” button 1706 is further provided within the window 1700 to allow a user to select from a variety of logos stored by the content server 102.

A hyperlink field 1708 may also be provided within the window 1700 that allows a user to enter a hyperlink or a URL to a web page within a selected logo. Upon selection or clicking of the logo within an electronic message, the web page corresponding to the link will be presented.

Further selectable attributes may be provided to the user, such preferred alignments of the logo (i.e. horizontal, vertical, top, center, and bottom) within the template.

A logo gallery window 1800 (FIG. 18) may be presented upon selection of the choose logo button 1706 above. The window 1800 may include a plurality of categories 1802 of logo images available and thumbnails of such images for each selected category. The window 1800 may further include an “upload” button 1804 to allow a user to add their own logo to the template. The user is allowed to select a logo in any known data format from their hard-disk, after which the logo is uploaded to the content server 102. A “browse” button 1806 may be provided to allow a user to browse their local hard drive for such images. Users can thus upload their own images (i.e., .GIF or .JPG files) which will automatically be embedded in all electronic messages having the template, as well as any such messages generated with a shared version of the template.

The logos may include calls to real-time information, such as news headlines, weather reports, stock quotes and the like, which may be updated over the Internet in real time within an open electronic message, and may further be presented as a moving “ticker.”

In certain embodiments, an uploaded logo is stored with respect to the template only, and if the template is later deleted from the content server 102 by the user, the logo is deleted as well in order to conserve memory.

Any logos selected in step 1314 will be presented within the template preview pane 1512.

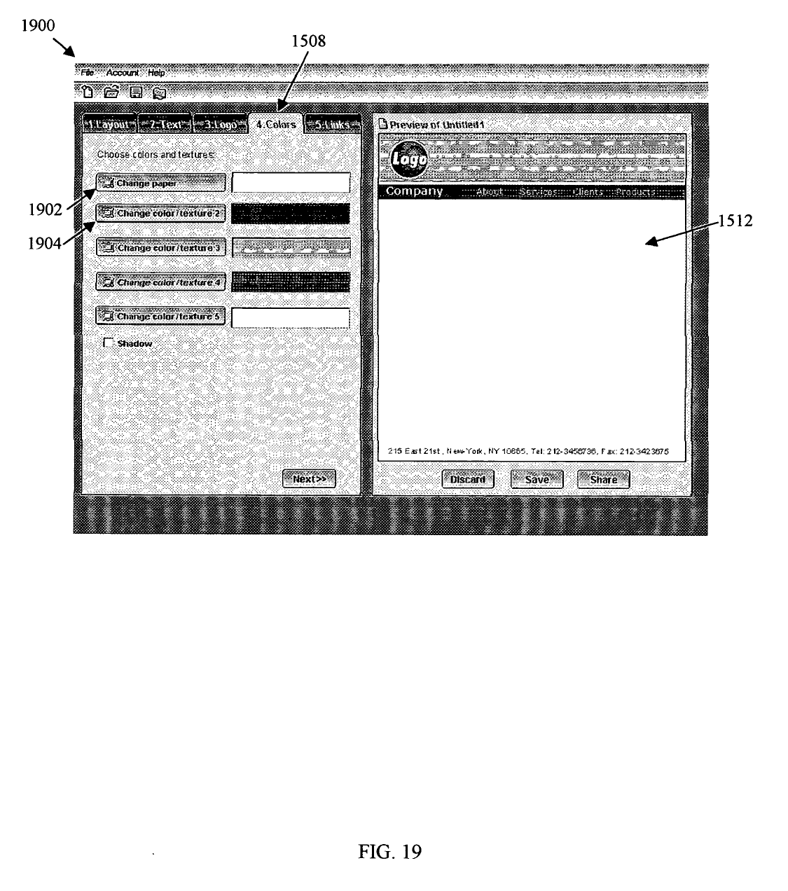

After selection of any logos for the new template, and upon selecting the colors tab 1508, the user is next presented with a color/texture selection window 1900, an example of which is shown in FIG. 19. This window 1900 allows a user to select colors and textures for the background of the generated template (step 1316).

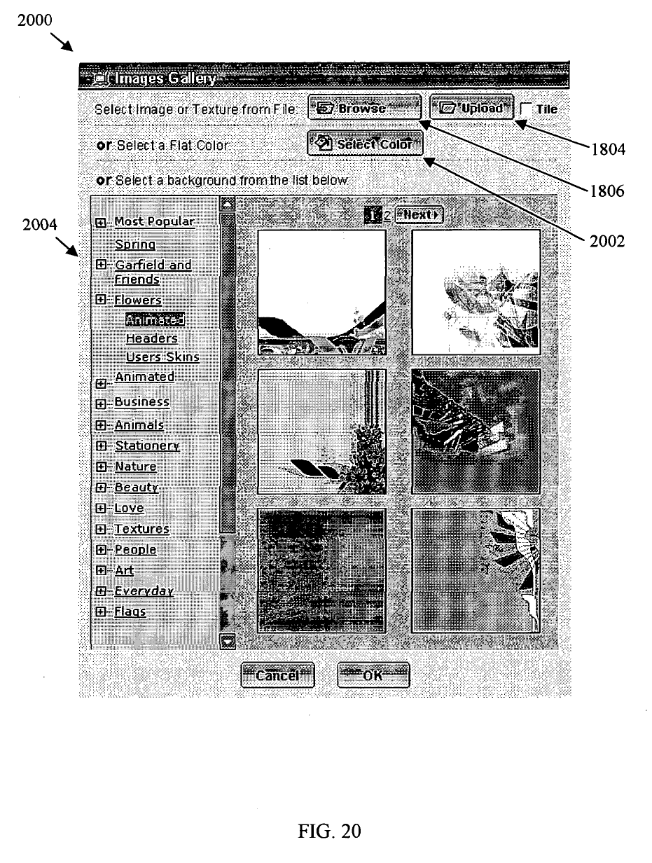

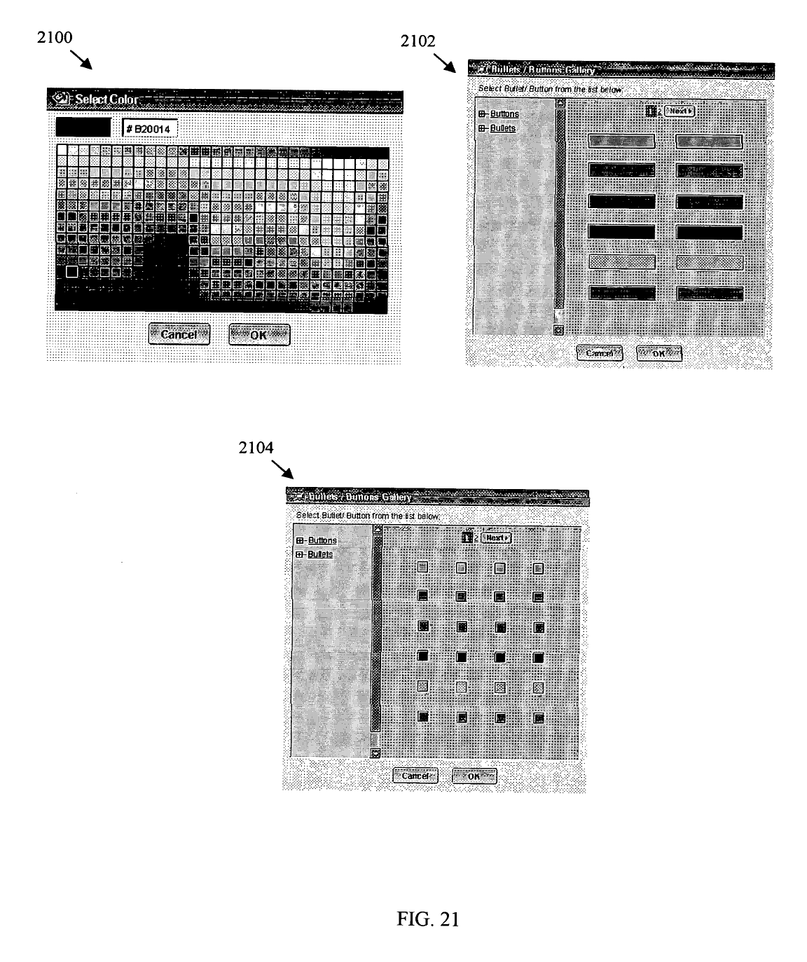

The window 1900 may include a “change paper” button 1902 for changing the background texture of a generated message template. Selecting a texture or “paper” affects the entire background of the template. Available textures may be arranged in a category tree, such as the list 2004 of FIG. 20, and images of the textures may be previewed within one or more thumbnail images presented.

Each texture may include a selectable parameter specifying whether the texture is to be tiled or not within the template. Such a parameter may further define whether the texture is to appear as a horizontal, vertical, or centered area.

A background color selector window 2000, an example of which is shown in FIG. 20, may be presented upon selection of a “change color” button 1904 by the user. This window 2000 allows the user to upload a color file for the background to the content server 102, or select a flat color provided by the content server 102.

The color palette 2100 of FIG. 21 may be presented upon selecting the select color button 2002 within the window 2000. The color palette may, in certain embodiments, be presented as an HTML DIV element. The color palette allows a user to select a color tile or to enter a hexadecimal color code representing the color into the template.

The template preview pane 1512 automatically displays any colors or textures selected.

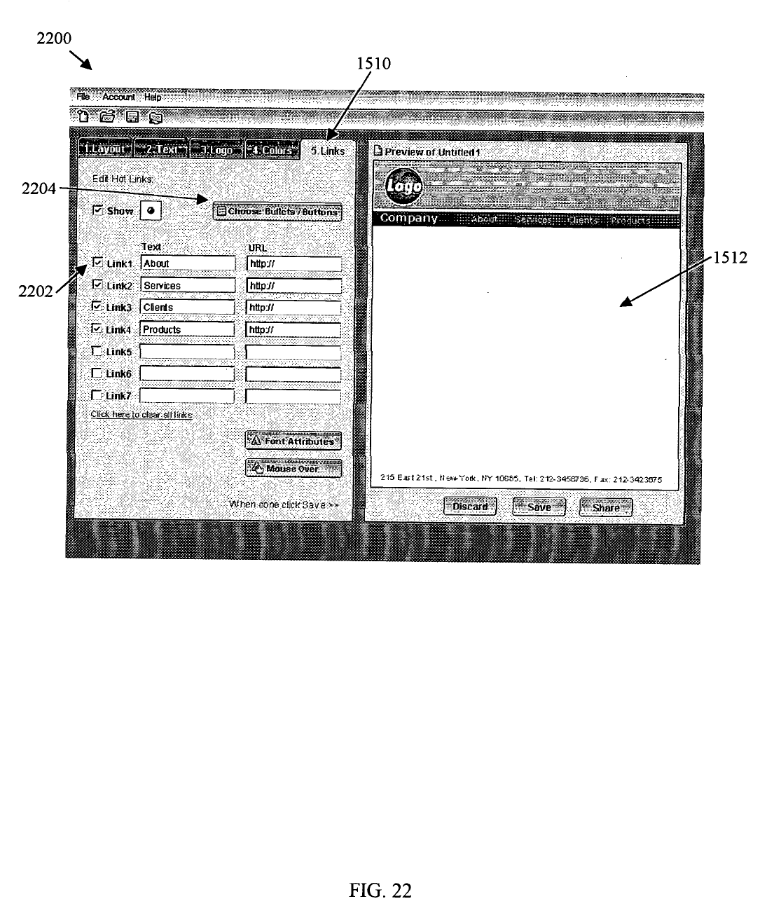

After selection of colors and textures, and upon selecting the links tab 510, the user is next presented with a hyperlink selection window 2200, an example of which is shown in FIG. 22. This window 2200 allows a user to enter any hyperlinks to be included in the template (step 1318), aside from any links already selected for the logos above.

All links entered in the window 2200 may have the same appearance, i.e. the same button, font attributes, and mouse-over attributes. Buttons may be provided for allowing the user to change the font attributes, including font face, style, size, color of any inserted links. The mouse-over attributes change the appearance of a link when a mouse cursor is placed over the link in an electronic message or in the template preview window 1512.

Selection of a “choose bullets/buttons” button 2202 allows the user to select a bullet or button graphic that may be presented in a bullet selection window 2102 or a button selection window 2104, respectively, examples of which are displayed in FIG. 21. All links will then appear in accordance with any selected bullet or button in the template preview pane 1512, as well as in the template presented within an electronic message.

Clicking on a link inserted within a template in an electronic message window opens a web page corresponding to a link's URL in a new Internet browser window. Such links may be functional within the template preview pane 1512 as well.

Returning to the process 1300, after entry of any links, the user finally selects sharing and management options for the new template and may save the template locally and/or upload it to the content server (step 1320). These functions may be accessed using the menu bar 1514. Additional windows (not shown) may also be provided for receiving user selections of sharing, management, reporting, saving, and re-naming commands.

In particular embodiments, the user generating a template may designate that the template is only editable by that user. Accordingly, when the template is open in an electronic message, all of its elements (e.g. logo, background, links, text areas) are locked and not editable, or erasable by the recipient.

The user may also designate whether the template may be shared with one or more other users, independently of whether the template is alterable by other users. When the user re-names a shared template, any other user's links to the previous template are still functional, and may be functional to receive the old and/or the new version of the template. If the template has been updated, or deleted, then the shared template may likewise be updated or deleted.

A template may be shared with another user by transmitting an electronic message to the other user with a link to the shared template. The message may be generated by the user or by the content server 102. The other user must be a valid user and have the plug-in in order to automatically include the shared stationery in new electronic messages. However, any second party recipient may view the template within a received electronic message, whether or not they are a valid user. A valid user receiving a shared template may share it with further designated users in like manner. The further designated user may link to the second user's template or to the original template of the original user.

Additionally, the user generating a customized template may designate that the template may be shared by all users, in which case the template may be provided to any user via the layout selection window 1500.

As described previously, template attributes are stored at the content server 102. Consequently, when a programming call to a template is made, the updated template is automatically transmitted and presented within the message from which the call was activated. Therefore, whenever the user updates the template, all messages (whether opened by the user or a recipient) are thus automatically updated due to this functionality. Previous messages that included a call to the prior template may likewise be automatically updated when opened after the changes have been entered. In addition, the automatic updating may take place after a predetermined time. The user may also manually update any templates by clicking a link. In this manner, the user can embed and even automatically update promotions in all electronic messages sent by any party using a shared template.

During step 1320, the user may also be presented with reporting options to be generated for a stored template. Reporting options include: a number of electronic messages having the user's template that have been sent by any user, the number of such electronic message that have been opened by recipients, and a number of “click-throughs” of the link performed by such recipients, organized according to links selected. The tally of these reported figures may be performed by tracking the number of programming calls received by the content server 102 for the template, and determining the address of the user or recipient who activated the programming call (i.e. opening the electronic message). In this or equivalent manners, a user may continuously monitor the viral impact of promotions or the like that are distributed via such customized electronic message templates.

After entry of the sharing and management options, the process 1300 ends.

In further embodiments of the present disclosure, the content server 102 may optionally use user-generated templates for self-promotion by including a link therein to a web page where the plug-in may be downloaded by a message recipient.

It should be readily appreciated that any number of windows may be presented in conjunction with the SC tools and that the exemplary windows described herein are not to be construed as restrictive of the manners in which users may select template features. Users are likewise not restricted to selecting template features in the order described above. Nothing described herein or shown in the Figures should be construed to limit the scope and attributes of the content available for insertion into electronic messages via the processes described herein.

Although the invention has been described in detail in the foregoing embodiments, it is to be understood that the descriptions have been provided for purposes of illustration only and that other variations both in form and detail can be made thereupon by those skilled in the art without departing from the spirit and scope of the invention, which is defined solely by the appended claims.

What is claimed is:

1. A method for allowing customization of electronic messages, comprising:
receiving, from a user, a selection of a message template for an electronic message to be transmitted to a second party; and
transmitting an embedded programming call to a network location of the message template for insertion into the electronic message, the embedded programming call enabling transmission and display of the message template within the electronic message when opened.

2. The method of claim 1, further comprising:
transmitting the message template for display in the electronic message prior to transmission of the electronic message to the second party.

3. The method of claim 1, the message template comprising a customized message template generated and shared by a third party.

4. The method of claim 3, wherein the shared message template is unalterable by the user.

5. The method of claim 1, wherein the message template is not stored within the electronic message.

6. The method of claim 1, further comprising:
receiving a request for the message template, the request generated by the embedded programming call after the electronic message has been received by the second party; and
transmitting the message template for display within the electronic message opened by the second user.

7. The method of claim 6, further comprising:
receiving a change to the message template; and
transmitting the changed message template to the second user whenever the electronic message is opened by the second party after the change.

8. The method of claim 1, the message template comprising at least one of:
a custom color, a text, a hyperlink, and a graphical advertisement selected by the user.

9. The method of claim 1, further comprising:
providing a plug-in to the user, the plug-in for enabling the user to generate the message template within an electronic mail program.

10. The method of claim 9, wherein the user is a subscriber of a service providing the plug-in.

11. The method of claim 9, wherein the second party is not a subscriber of a service that provides the plug-in.

12. The method of claim 1, further comprising:
receiving an indication of a selection of a hyperlink in the message template; and
transmitting a notification to the user of the selection.

13. A method for customizing electronic messages, comprising:
receiving a customized message template from a first user;
transmitting the customized message template to a second user;
receiving a revision to the message template from the first user; and
automatically inserting the revision into an electronic message that is generated by the second user having the message template when the electronic message is opened.

14. The method of claim 13, wherein the electronic message is generated before the revision and opened after the revision.

15. The method of claim 13, the electronic message for transmission from the second party to a third party; the method further comprising:
receiving a revision to the customized message template from the first user; and
transmitting the revised customized message template for display in the electronic message in response to the embedded programming call when the electronic message is opened by the third party.

16. The method of claim 15, wherein the third party is not a subscriber to a service providing the message template.

17. The method of claim 13, wherein the customized message template is not editable by the second user.

18. A method for generating a customized template for an electronic message, comprising:
storing a customized message template on a server, the customized message template generated by a user and including a selectable link to a network address;
transmitting an embedded call to the customized message template for insertion into an electronic message;
transmitting the customized message template for display within the electronic message in response to a request from the embedded call that is automatically transmitted when the electronic message is opened.

19. The method of claim 18, further comprising:
receiving at least one indication of a selection of the selectable link; and
transmitting a report to the user indicating a number of times the selectable link was selected.

20. A computer-readable medium encoded with processing instructions for implementing a method, performed by a computer, for allowing customization of electronic mail messages, the method comprising:
receiving, from a user, a selection of a message template for an electronic message to be transmitted to a second party; and
transmitting an embedded programming call to a network location of the message template for insertion into the electronic message, the embedded programming call enabling transmission and display of the message template within the electronic message when opened.

21. An apparatus for allowing customization of electronic mail messages, comprising:
means for receiving, from a user, a selection of a message template for an electronic message to be transmitted to a second party; and
means for transmitting an embedded programming call to a network location of the message template for insertion into the electronic message, the embedded programming call enabling transmission and display of the message template within the electronic message when opened.

22. An apparatus for allowing customization of electronic mail messages, comprising:
a processor; and
a memory in communication with the processor, the memory for storing a plurality of processing instructions directing the processor to:
receive, from a user, a selection of a message template for an electronic message to be transmitted to a second party; and
transmit an embedded programming call to a network location of the message template for insertion into the electronic message, the embedded programming call enabling transmission and display of the message template within the electronic message when opened.
